(19) United States
(12) Patent Application Publication
(10) Pub. No.: US 2016/0056909 A1
(43) Pub. Date: Feb. 25, 2016

(54) RADIO BASE STATION, USER TERMINAL AND RADIO COMMUNICATION METHOD

(71) Applicant: NTT DOCOMO, INC., Tokyo (JP)

(72) Inventors: Shimpei Yasukawa, Tokyo (JP); Yoshihisa Kishiyama, Tokyo (JP); Satoshi Nagata, Tokyo (JP); Yuichi Kakishima, Tokyo (JP)

(73) Assignee: NTT DOCOMO, INC., Tokyo (JP)

(21) Appl. No.: 14/781,355

(22) PCT Filed: Mar. 10, 2014
(86) PCT No.: PCT/JP2014/056194

§ 371 Date: Sep. 30, 2015

(30) Foreign Application Priority Data
Apr. 2, 2013 (JP) 2013-077104

(51) Int. Cl. H04J 11/00; H04W 24/02

(52) U.S. Cl. CPC H04J 11/0053; H04W 24/02

(57) ABSTRACT

The present invention is designed to reduce interference between cells even when a plurality of cells are placed at a high density. In a radio base station, a receiving section that receives an uplink signal transmitted from a user terminal, and an interference estimation section that estimates the level of interference received from an other cell based on an uplink signal transmitted from a user terminal of the other cell, are provided, and the interference estimation section estimates the level of interference of each cell based on the uplink signal, and a blank state is assumed in the uplink signal at a resource position that varies on a per cell basis. Furthermore, a control section that controls a predetermined resource position in an uplink signal transmitted from a serving user terminal to assume the blank state, is provided.

### TECHNICAL FIELD

The present invention relates to a radio base station, a user terminal and a radio communication method in a next-generation mobile communication system.

### BACKGROUND ART

In a UMTS (Universal Mobile Telecommunications System) network, the specifications of long-term evolution (LTE) have been drafted for the purposes of further increasing high-speed data rates, providing low delay and so on (non-patent literature 1). In LTE, as multiple access schemes, a scheme that is based on OFDMA (Orthogonal Frequency Division Multiple Access) is used in downlink channels (downlink), and a scheme that is based on SC-FDMA (Single-Carrier Frequency Division Multiple Access) is used in uplink channels (uplink).

Also, successor systems of LTE (referred to as, for example, “LTE-advanced” or “LTE enhancement” (hereinafter referred to as “LTE-A”)) have been under study for the purpose of achieving further broadbandization and increased speed beyond LTE. In an LTE-A system, a HetNet (Heterogeneous Network), in which small cells (for example, pico cells, femto cells and so on) having a local coverage area of a radius of approximately several tens of meters are formed inside a macro cell having a wide coverage area of a radius of approximately several kilometers, is under study (see, for example, non-patent literature 2).

Also, in relationship to the HetNet, a study is in progress to use carriers of different frequency bands between the macro cell and the small cells.

### CITATION LIST

### Non-Patent Literature

Non-Patent Literature 1: 3GPP TS 36.300, “Evolved UTRA and Evolved UTRAN Overall Description”

Non-Patent Literature 2: 3GPP TR 36.814, “E-UTRA Further Advancements for E-UTRA Physical Layer Aspects”

### SUMMARY OF INVENTION

### Technical Problem

In the above HetNet, many small cells may be placed in the macro cell. In this case, in places where small cells are placed at a high density, there is a threat that interference is produced between the small cells. For example, where there is a radio base station (for example, a small base station) forming a given cell, there is a threat that an uplink signal transmitted from a user terminal of a nearby cell may interfere with this radio base station.

Now, in order to reduce the interference between the small cells, interference coordination is under study. In interference coordination, it is preferable to specify the cells that are the source of interference, and carry out interference control. However, when carriers of a common frequency band are used between the macro cell and the small cells, the small cells receive dominant interference from the macro cell (its serving user terminals). On the other hand, when carriers of different frequency bands are used between the macro cell and the small cells, given that the small cells are placed at a high density, it is difficult to specify from which small cells (serving user terminals) interference is received.

The present invention has been made in view of the above, and it is therefore an object of the present invention to provide a radio base station, a user terminal and a radio communication method, whereby, even when a plurality of cells are placed at a high density, it is still possible to effectively reduce the interference between the cells.

### Solution to Problem

A radio base station, according to the present invention, is a radio base station having a receiving section that receives an uplink signal transmitted from a user terminal, and an interference estimation section that estimates a level of interference received from an other cell based on an uplink signal transmitted from a user terminals of the other cell, and the interference estimation section estimates the level of interference of each cell based on the uplink signal, and a blank state is assumed in the uplink signal at a resource position that varies on a per cell basis.

### Advantageous Effects of Invention

According to the present invention, even when a plurality of cells are placed at a high density, it is still possible to specify the cells being the source of interference, and reduce the interference between the cells.

### BRIEF DESCRIPTION OF DRAWINGS

FIG. 1 is a conceptual diagram of a HetNet;

FIG. 2 is a diagram to explain methods of connecting between a macro base station and small base stations, and between small base stations;

FIG. 3 is a diagram to explain uplink DM-RSs;

FIG. 4 is a diagram to illustrate a case where predetermined RE positions in uplink DM-RSs are made blank;

FIG. 5 provides diagrams to illustrate an example of a method of specifying the source of interference according to a first example;

FIG. 6 is a diagram to illustrate an example of sending an interference specifying report from an interfered cell to an interfering cell;

FIG. 7 is a diagram to explain SRSs;

FIG. 8 is a diagram to illustrate an example of a method of specifying the source of interference according to a second example;

FIG. 9 is a schematic diagram to illustrate an example of a radio communication system according to the present embodiment;

FIG. 10 is a diagram to explain an overall structure of a radio base station according to the present embodiment;

FIG. 11 is a diagram to explain a functional structure of a small base station according to the present embodiment;

FIG. 12 is a diagram to explain an overall structure of a user terminal according to the present embodiment; and

FIG. 13 is a diagram to explain a functional structure of a user terminal according to the present embodiment.

### DESCRIPTION OF EMBODIMENTS

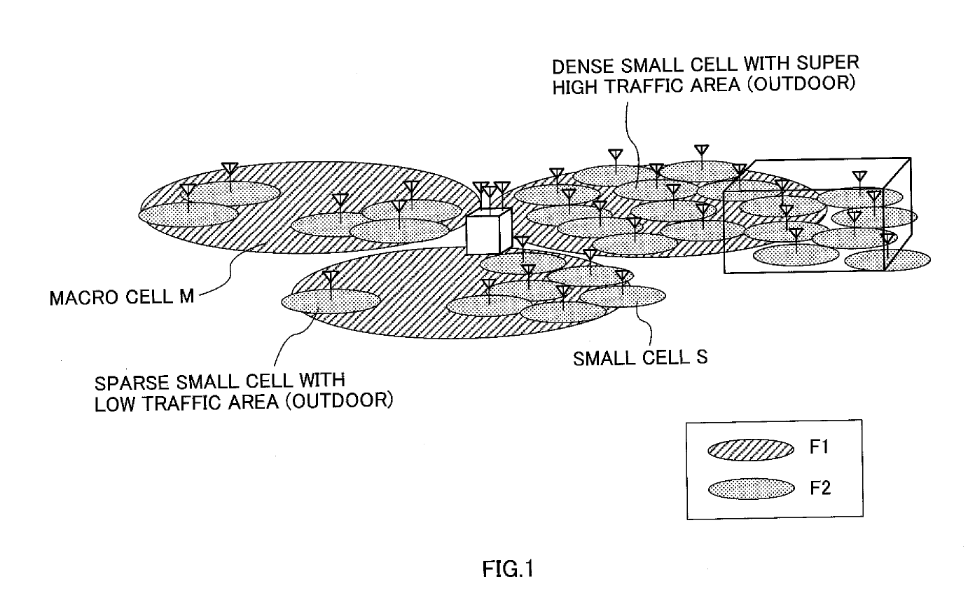

FIG. 1 is a conceptual diagram of a HetNet. As illustrated in FIG. 1, a HetNet refers to a radio communication system in which macro cells M and small cells S are arranged to geographically overlap each other at least in part. The HetNet is comprised of radio base stations that form macro cells M (hereinafter referred to as “macro base stations”), radio base stations that form small cells S (hereinafter referred to as “small base stations”), and user terminals UE that communicate with the macro base stations and the small base stations.

As illustrated in FIG. 1, in the macro cells M, a carrier F1 (hereinafter referred to as the “low frequency band carrier”) of a relatively low frequency band—for example, 800 MHz or 2 GHz is used. On the other hand, in the small cells S, which are provided in a large number, a carrier F2 (hereinafter referred to as the “high frequency band carrier”) of a relatively high frequency band—for example, 3.5 GHz—is used. Note that 800 MHz, 2 GHz and 3.5 GHz are only examples. 3.5 GHz may be used for the carrier for the macro cells M, and 800 MHz, 2 GHz 1.7 GHz and others may be used for the carrier for the small cells S.

In this way, a scenario (separate frequencies) to employ different frequencies between a small cell S and a macro cell M is under study for radio communication systems of LTE-A (Rel. 12 and later versions). In this case, it may be possible to use the macro cell M and the small cell S, which use different frequencies, simultaneously, by means of CA (carrier aggregation).

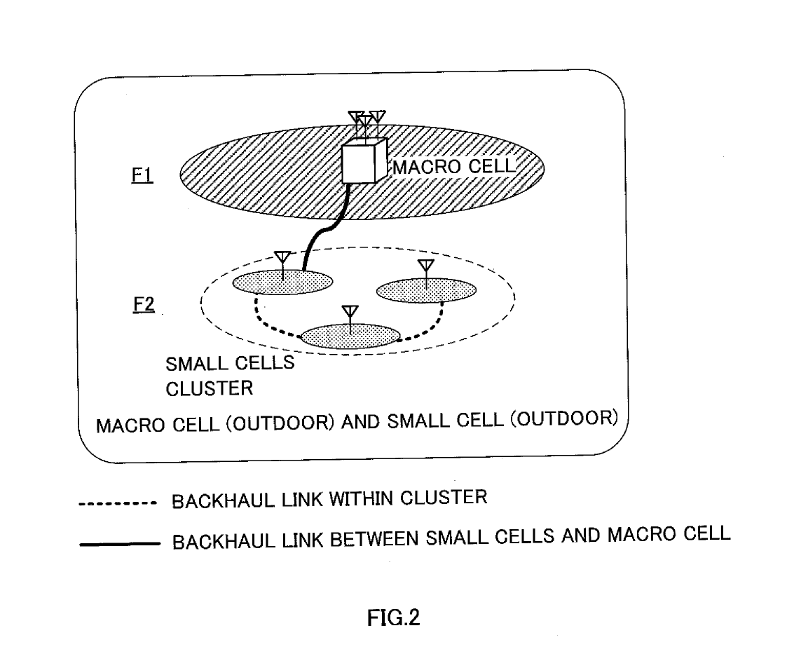

FIG. 2 illustrates examples of connections between base stations in the scenario in which small cells S and a macro cell M employ separate frequencies. As illustrated in FIG. 2, the connection between the macro base station and the small base stations, or the connection between the small base stations, may be implemented by wire connection such as optical fiber and non-optical fiber (X2 interface), or by radio connection. Note that a connection between base stations will be referred to as an “ideal backhaul” if information is transmitted and received by using optical fiber with low delay. On the other hand, a connection may be referred to as a “non-ideal backhaul” when implemented by using non-optical fiber such as the X2 interface. In comparison with a non-ideal backhaul, an ideal backhaul can control the transmission and reception of information between base stations with low delay.

When small cells S are connected via an ideal backhaul, it becomes possible to transmit and receive signals with low delay, so that it is possible to learn the resource allocation and reference signal sequences in other small cells S. From the perspective of sharing information between base stations, it is preferable to connect between the base stations via an ideal backhaul. On the other hand, when many small base stations S are provided, it may be possible to connect between the small base stations S via a non-ideal backhaul from the perspective of cost and so on.

Even when small cells S are connected via a non-ideal backhaul, it is still possible to synchronize between the small cells S on a certain level (on the symbol level or on the frame level). However, when there is significant backhaul delay, the resource allocation and reference signal sequences in other small cells S cannot be learned at all or can be learned only partially. Consequently, when controlling the operation between the small base stations S, it is necessary to execute control that is at least semi-static.

Now, generally speaking, in radio communication systems, the distribution of users and the load of traffic are not fixed, but change over time or between locations. Consequently, when many small cells S are placed in a macro cell M, the small cells may be placed in such a manner that their density and environment vary (sparse and dense) between locations, as illustrated in FIG. 1.

When a large number of small cells are provided, the small cells are likely to be provided based on a flexible area design, unlike conventional macro cells, with which the places to provide the cells are studied meticulously by drafting an area design. For example, it may be possible to raise the density of placing small cells S (dense small cells) in train stations, shopping malls and so on where many user terminals gather, and lower the density of placing small cells S (sparse small cells) in places where user terminals do not gather.

In this way, when small cells S are placed in varying densities between locations, it may be possible that the interference between the small cells increases locally in areas where the small cells are placed at a high density. Also, near hotspots where small cells S gather closely, the arrangement of small cells and the distribution of users become uneven, so that it is likely that unevenness is produced in interference as well. Furthermore, there is a possibility that interference increases locally upon off-loading from small cells that gather closely (crowded small cells) to small cells that are placed at a low density (sparse small cells).

Generally speaking, the path loss is insignificant in a small cell environment, and, while the transmission power of user terminals cam be made small compared to a macro cell environment, interference is produced when the density of small cells is high. Also, as for interference between small cells, the case where nearby cells receive significant interference due to specific user terminals, and the case where interference from a plurality of user terminals poses a problem may occur.

Consequently, for interference coordination between small cells, it may be possible to adjust the average interference level (the amount of interference) by controlling TPC parameters in nearby cells of an interfered cell. However, compared to macro cells, small cells have many factors that make IoT (Interference over Thermal noise) high locally. Consequently, it is preferable to carry out interference control, on a per cell basis, depending on the level of interference from each cell.

In a co-channel HetNet in which the macro cell M and the small cells S use the same frequency, user terminals to serve the macro base station are primarily the user terminals to be the source of interference (interfering UEs). By contrast with this, in the above scenarios illustrated in FIG. 1 and FIG. 2, it is not possible to easily identify which small cell the source of interference (interfering UE) is connected to.

Note that estimating the level of interference from nearby cells alone, without specifying the source of interference (for example, a cell in which an interfering UE is present), is possible by using existing DM-RSs and so on. However, in order to execute interference coordination between small cells more adequately, it is necessary to estimate from which cells interference is received.

So, the present inventors have focused on uplink signals that are transmitted from the user terminals of other cells, in order to specify interfering cells (or specific interfering UEs), and conceived of estimating the source of interference (interfering cell and/or interfering UE) and the level of interference (the amount of interference) by adjusting these uplink signals for use for measuring interference.

To be more specific, the present inventors have found out estimating each cell's interference level by blanking (muting) part of the resources (REs: Resource Elements) of the uplink signals (the PUSCH and/or uplink DM-RSs) in different positions per cell. In this case, every cell (interfered cell) is able to estimate the interference source cell (interfering cell), including the amount of traffic.

Furthermore, the present inventors have found out, as another method, orthogonalizing the reference signals for use for measuring channel quality (SRSs: Sounding Reference Signals) on a per cell basis (time/code orthogonalization), and estimating the level of interference from each cell by measuring the signal level from the user terminals of nearby cells. In this way, an interfered cell can estimate the interference source cell with high accuracy, by demodulating the SRSs of other cells' user terminals.

Now, the present embodiment will be described below in detail with reference to the accompanying drawings. Note that the following first example and second example may be combined and implemented as appropriate.

### First Example

A case will be described with a first example where the level of interference (the amount of interference) from each cell is estimated by blanking (muting) an uplink signal in different RE positions between cells.

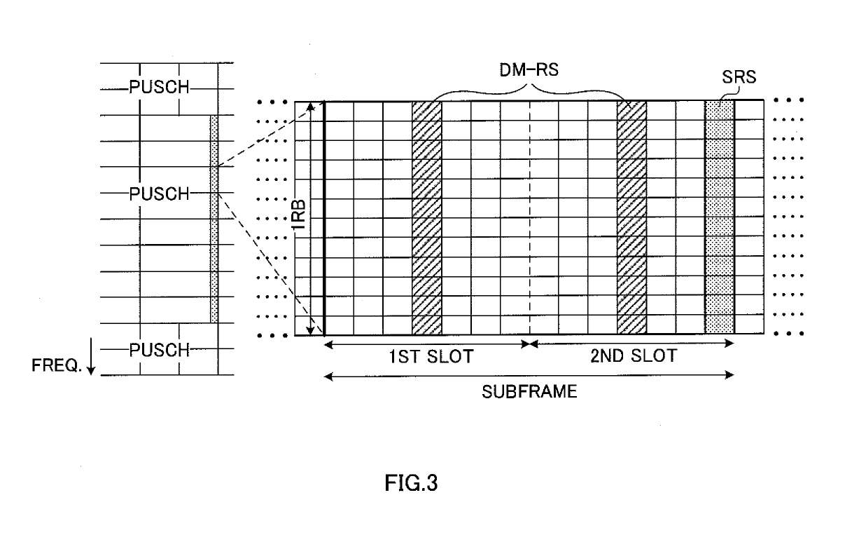

With the first example, the PUSCH signal and/or the DM-RS can be used as the uplink signal. The PUSCH refers to a data channel that is used to transmit user data. The DM-RS refers to a reference signal that is used to demodulate the PUSCH/PUCCH (channel estimation), and is multiplexed and transmitted over the resource block (RBs) where the PUSCH/PUCCH is transmitted (see FIG. 3). In the event of the DM-RS for the PUSCH, the DM-RS is multiplexed over the third SC-FDMA symbol in each slot.

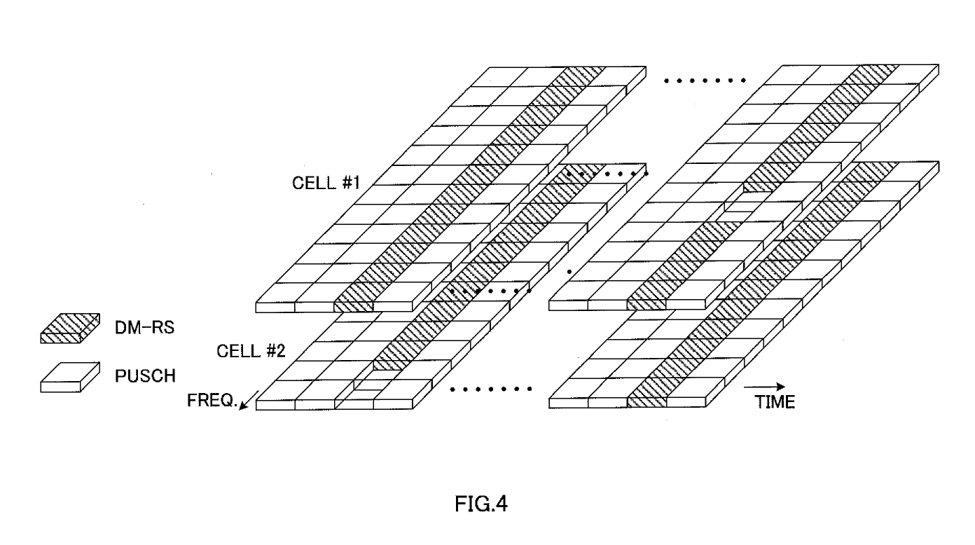

An example case is illustrated in FIG. 4 where the user terminals serving each cell (here, cell #1 and cell #2) make predetermined RE positions of the uplink DM-RSs blank (blanking). To be more specific, in cell #1, two REs on the DM-RS, placed in the second half with respect to the time axis, are made zero power, while, in cell #2, two REs on the DM-RS, placed in the first half with respect to the time axis, are made zero power.

That is, each cell's radio base station controls the serving user terminals to carry out transmission by making predetermined resource positions in uplink signals assume a blank state. In this case, user terminals that are connected to the same cell (for example, cell #1) use the same blanking pattern (muting pattern).

Also, although FIG. 4 illustrates a case where the transmission power is made zero (zero power) in predetermined REs that are made blank, it is equally possible to reduce the transmission power of the REs that are made blank, instead of making these REs zero-power, and transmit these. In this case, the user terminals transmit the uplink signals by setting the transmission power of the REs that assume the blanking pattern lower than in other REs.

Also, the pattern of REs to make blank in each cell (shift pattern) can be made common between PRBs. In this case, the patterns of REs to make blank in each cell (shift patterns) can be configured in association with the cell IDs. Alternatively, the blanking RE patterns may be reported to other cells semi-statically by using higher layer signaling (for example, RRC signaling) and so on. Also, the number of patterns that may be assumed per FRB is: 12/the number of REs to make zero power. In FIG. 4, the number of patterns is six.

The patterns of REs to make blank can be made common in all symbols and/or subframes. Alternatively, the symbols and/or subframes to make blank may be prepared in multiple patterns. In this case, it is possible to increase the number of blanking RE patterns.

Every cell (interfered cell) estimates the level of interference, per cell, based on uplink signals transmitted from other cells' user terminals. Note that, as described above, in the uplink signals transmitted from other cells, the blank state is assumed (set) in resource positions that vary between the cells.

To be more specific, the power is measured per blanking pattern, in each cell, and each cell's interference level is estimated. For example, the level of interference (Iₖ) from a given cell k can be calculated by using following equation 1 or equation 2.

$$\begin{matrix}( Equation 1 ) & \\ {I}_{k} = \frac{{\sum }_{i ∈ {Ω}_{k}} {\sum }_{j ∈ {Ω}_{k}} {S}_{i , j}}{{\sum }_{i ∈ {Ω}_{k}} {{\sum }_{j}}^{{N}_{SC}} {S}_{i , j}} & [ 1 ] \\ ( Equation 2 ) & \\ {I}_{k} = \frac{{\sum }_{i ∈ {Ω}_{k}} {\sum }_{j ∈ {Ω}_{k}} {S}_{i , j}}{{\sum }_{i ∈ {Ω}_{k}} {{\sum }_{j}}^{{N}_{SC}} {S}_{i , j}} ( K - 1 ) & [ 2 ]\end{matrix}$$

In equation 1 and equation 2:

k: the cell ID;

Ωₖ: the cell-specific blanking pattern (the set of the symbol index numbers and the subcarrier index numbers subject to blanking);

K_{f}: the total number of blanking patterns on the frequency axis;

i: the symbol index number;

j: the subcarrier index number;

N_{SC}: the total number of subcarriers of the PUSCH or the DM-RS;

s_{i,j}: the received power of the REs; and

K: the number of blanking patterns.

In above equation 1, the power of the REs that are made blank in cell k (serving user terminal) and the power of all REs are compared. Also, in above equation 2, the power of the REs that are made blank in cell k and the power of the REs that are not made blank in cell k are compared. That is, equation 1 and equation 2 each illustrate the transmission power ratio between the REs in the blank state in cell k and the other REs, and, if Iₖ is small, it is possible to determine that the level of interference from cell k is large.

In this way, it is possible to estimate the level of interference from each cell based on the power of REs that are made blank in each cell. Note that the level of interference may be estimated taking the whole band into account, or may be calculated on a per subband basis.

Also, the level of interference received from other cells may be determined in specific subframes, or may be determined by finding an average between subframes. Also, when calculating the level of interference (power measurement), each cell may subtract the signal power from the user terminals serving the subject cell.

Now, there is a concern that the cubic metric (CM) grows (the PAPR varies more significantly) following blanking, and causes deterioration of single-carrier performance. Consequently, it is preferable to define and apply MPR (Maximum Power Reduction) (reduce the transmission power) in accordance with the blanking pattern. Note that the transmission power to be required is low in a small cell environment, so that there is little impact even when MPR increases.

Also, each cell does not have to carry out the method of specifying the source of interference (estimating the level of interference) on a constant basis, and may carry out the method at predetermined times. For example, a cell that receives strong interference from other cells may carry out the above-described interference source cell specifying method.

Also, each cell does not have to carry out blanking on a constant basis. For example, it is possible to use a configuration in which blanking is executed only when there are nearby cells that receive strong interference. In this case, whether or not there are cells (interfered cell) nearby that are receiving strong interference may be determined based on, for example, an interference report sent from the interfered cell using the backhaul.

By this means, every cell can be configured to carry out blanking only while interference coordination is executed in nearby cells including interfered cells. As a result of this, it is possible to improve the efficiency of the use of radio resource used by user terminals, and reduce the deterioration of overhead and signal quality.

<Method of Estimating the Source of Interference>

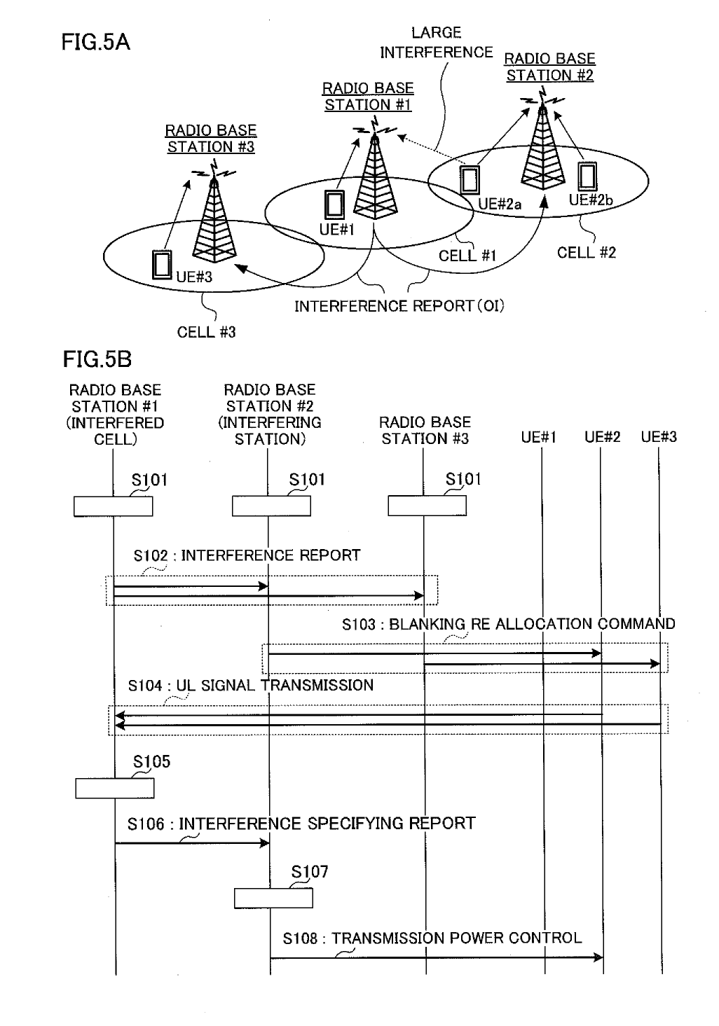

Now, an example of a method of specifying the source of interference (interfering cell) according to a first example will be described below with reference to FIG. 5.

FIG. 5A illustrates an example of a radio communication system according to the first example. The radio communication system of FIG. 5A is formed by including a plurality of transmitting/receiving points (here, radio base stations #1 to #3 that form cells #1 to #3, respectively), and user terminals 41 to #3 that are connected to radio base stations 41 to #3, respectively. Note that radio base stations #1 to #3 are able to communicate information with each other through wire connection such as the X2 interface and so on, or through radio connection.

Now, with reference to FIG. 5B, a case will be described where, when radio base station #1 receives strong interference from cell #2 (user terminal #2 serving radio base station #2), radio base station #1 specifies the source of interference. Note that, although, in the following description, a case will be described in which the resources (REs) to be made blank in nearby cells are configured based on interference reports from interfered cells, the present embodiment is by no means limited to this. It is equally possible to configure the resources to make blank at predetermined times in each cell.

First, each cell measures the level of interference (the amount of interference) from nearby cells (S101). Without specifying the source of interference (interfering cell), the level of interference can be estimated by using existing DM-RSs and so on. FIG. 5 illustrates a case where radio base station #1 of cell #1 receives interference of an equal or higher level than a predetermined value from nearby cells (here, cell #2).

Radio base station #1, having determined that the level of interference being received from other cells is equal to or higher than a predetermined value, sends an interference report (OI: Overload Indicator), to the effect that radio base station #1 is receiving interference, to radio base station #2 and #3 of other cells (S102).

Upon receiving the interference report from radio base station #1, radio base stations #2 and #3 of other cells control the serving user terminals to transmit an uplink signal by making predetermined resource positions the blank state (S103). As for the uplink signal, the PUSCH and/or the DM-RS can be used. The blanking RE pattern which each user terminal employs can be the pattern that is associated with the cell ID of the connecting cell.

Each user terminal transmits the uplink signal based on the scheduling commanded from the connecting radio base station via a downlink control signal (S104). FIG. 5B illustrates a case where radio base station #1 (interfered cell) receives the uplink signals from user terminals #2 and #3 of other cells. Radio base station #1, estimates the level of interference per cell based on the uplink signals transmitted from other cells' user terminals, including blanking REs (S105).

For example, radio base station #1 can calculate each cell's interference level by using above-noted equation 1 or equation 2. As a result of this, radio base station #1 can specify the interfering cell (here, cell #2) that is causing interference. Also, when the blanking patterns are associated with each cell's cell ID, the cells to correspond to the blanking patterns are determined from the cell IDs of other cells. When the blanking patterns are not associated with cell IDs, it is possible to make decisions based on blanking pattern information that is reported from other cells.

<Method of Sending Report to the Source of Interference>

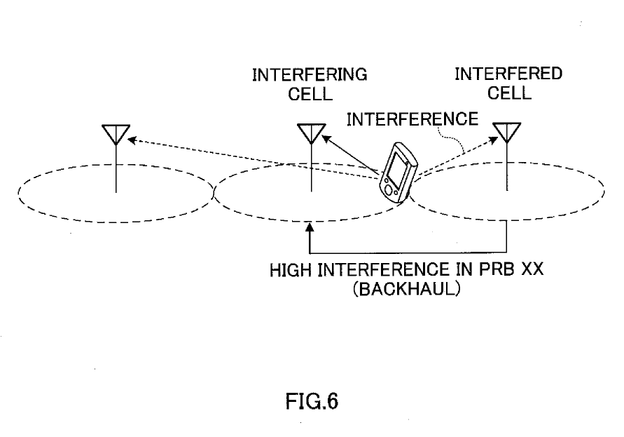

The interfered cell (radio base station #1 in FIG. 5) sends a report, to the effect that strong interference is being received (interference specifying report), to the interfering cell (cell #2) that is causing strong interference (S106 in FIG. 5). In this case, radio base station #1 can use the backhaul (for example, X2 interface) and transmit “UL high interference information” and “UL interference overload indication (low/mid/high),” which are already defined (see FIG. 6).

Also, radio base station #1 can send a report to the effect that the interference source cell has been specified, by using a newly defined format. Note that the interfered cell (radio base station #1) may add, to the interference specifying report, information about the time strong interference is observed, in addition to information about the resource blocks (RBs) on which interference has an impact. By this means, the interfering cell (radio base station #2) can specify the serving user terminal that is causing interference, based on the history of scheduling information in the subject cell.

Also, apart from the report to the interference source cell (radio base station #2), if the level of interference is reported without illustrating the interference source cell, it is possible to subtract the proportion of the interference by the interfering cell that is already estimated (for example, cell #2). By this means, it is possible to avoid executing unnecessary interference coordination in cells that are not the source of interference.

<Method of Specifying Interfering UE>

Radio base station #2, having received the interference specifying report from the interfered cell (radio base station #1), may specify the user terminal that is causing strong interference against the interfered cell among the serving user terminals (S107 of FIG. 5B). For example, if time information is included in the interference specifying report that is transmitted from the interfered cell, in addition to interference resource block information, radio base station #2 can specify the interfering UE (UE #2a in FIG. 5A) from the scheduling history.

Also if interference resource block information and time information are not included in the interference specifying report transmitted from the interfered cell, radio base station #2 may select specific user terminals among the serving user terminals, and makes these user terminals transmit uplink signals. To be more specific, specific user terminals (for example, user terminals where the path loss is significant) may be made to transmit the DM-RS, the PRACH and so on. Then, by measuring the level of interference based on the DM-RS, the PRACH and so on, on the side of the interfered cell, it is possible to specify the user terminal causing interference. At this time, the parameters (time and so on) of the uplink signals which the specific user terminals transmit may be reported to the interfered cell in advance.

Alternatively, uplink signal transmission/non-transmission control is applied to part of or all of specific user terminals (for example, user terminals where the path loss is significant) being the candidates of interfering user terminals. By this means, it is possible to narrow down the candidates of user terminals upon sending the next interference report, in accordance with changes in the level of interference in the interfered cell.

When the user terminal (interfering UE) being the source of interference is successfully specified, it is possible to execute adequate interference coordination based on the relationship between the interfered cell and the interfering cell. For example, when the interfered cell and the interfering cell use a common scheduler, it is possible to employ inter-cell coordinated transmission (CoMP) between radio base station #1 and radio base station #2.

Also, when separate schedulers are provided for the interfered cell and the interfering cell, the transmission power of the interfering UE is lowered to a predetermined value (S108 of FIG. 5B). Furthermore, when the level of interference is constantly high even when the transmission power of the interfering UE is lowered, it is possible to limit the resource allocation to this user terminal (or to cell edge user terminals, all the user terminals, etc.) in RB units.

Note that, when there is no dominant source of interference (interfering UE), it is possible to execute interference coordination near cells where the level of interference is constantly high, based on an interference report from the interfered cell. In this case, is possible to employ a configuration in which interference coordination is not executed in cells where the traffic is heavy.

### Second Example

A case will be described with a second example where the reference signal (SRS) for channel quality measurement is orthogonalized between cells, the signal level from the user terminals of nearby cells is measured, and the level of interference (the amount of interference) from each cell is estimated.

The SRS for channel quality measurement is a reference signal that is transmitted from user terminals to measure uplink channel quality. A radio base station carries out scheduling for allowing the user terminals to transmit the uplink shared channel (PUSCH: Physical Uplink Shared Channel) signal, based on channel quality measurement results, and sends commands by using a downlink control channel (PDCCH: Physical Downlink Control Channel).

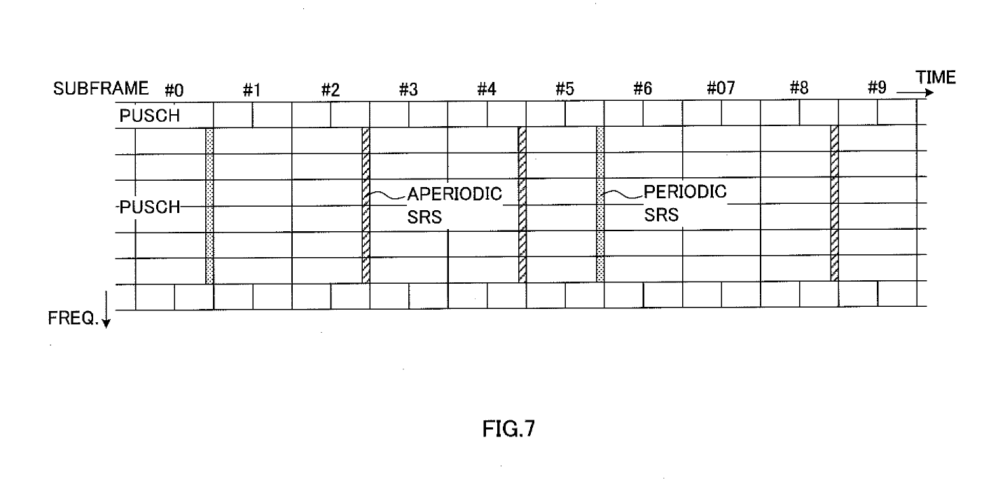

Also, in LTE (Rel. 8), the SRS is defined to be multiplexed over the last symbol of the subframes constituting the uplink radio frame, and transmitted from user terminals to radio base stations periodically. Furthermore, in LTE-A (Rel. 11), taking into account the time the PUSCH signal is transmitted, application of the aperiodic SRS, which controls the times to transmit the SRS to arbitrary times, is defined (see FIG. 7).

Also, when the SRS is transmitted, information about SRS transmission parameters (comb, frequency position, cyclic shift index number, bandwidth and so on), which controls the transmission conditions of the SRS, is reported from the radio base stations to the user terminals.

According to the second example, every cell demodulates the SRSs transmitted from other cells (user terminals connected to the small base stations of other cells), and estimates each cell's interference level from the signal levels of these SRSs. Then, based on each cell's interference level, cells that cause strong interference (interfering cells) are specified.

To demodulate the SRSs transmitted from other cells' user terminals, the SRS transmission parameters employed in the other cells (cell-specific and UE-specific parameters) are necessary. Each cell's SRS transmission parameters can be reported directly to other cells using a backhaul and so on. Alternatively, it is equally possible to employ a method which does not report SRS transmission parameters to other cells directly.

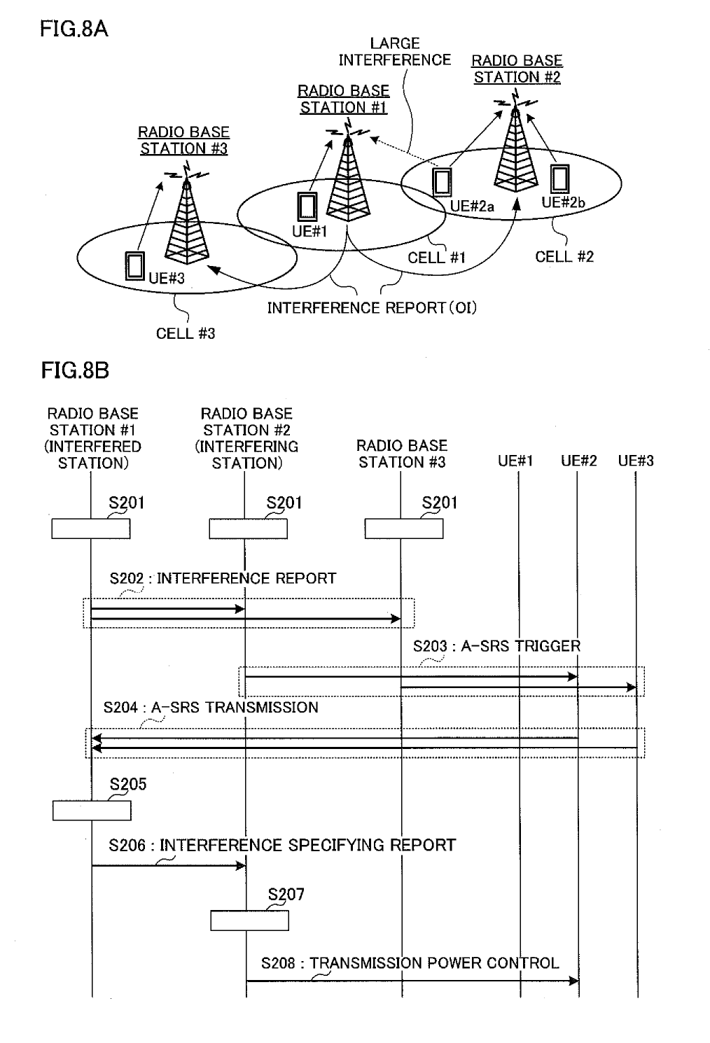

Now, with reference to FIG. 8, a case will be described below where SRS transmission parameters are not reported directly (a case to use virtual cell IDs). Note that, FIG. 8A illustrates an example of a radio communication system according to the second example. The radio communication system of FIG. 8A is formed by including, similar to above FIG. 5A, radio base station #1 to #3 that form cells #1 to #3, respectively, and user terminal #1 to #3 that are connected to radio base stations #1 to #3, respectively. Also, a case is illustrated here where, when radio base station #1 receives strong interference from cell #2 (user terminal #2 serving radio base station #2), radio base station #1 specifies the source of interference.

First, every cell measures the level of interference (the amount of interference) from nearby cells (S201). Radio base station #1, having determined that the level of interference being received from other cells is equal to or higher than a predetermined value, sends an interference report (OI), to the effect that radio base station #1 is receiving interference, to radio base station #2 and #3 of other cells (S202).

Each cell, having received the interference report from the interfered cell (radio base station #1), generates and transmits an aperiodic SRS by using a sequence of a virtual cell ID, which is associated with the cell ID of the interfered cell of the source of the report. To be more specific, radio base stations #2 and #3 of other cells having received the interference report from radio base station #1 command the serving user terminals to generate and transmit aperiodic SRSs (A-SRS trigger) using virtual cell ID sequences (S203). Note that, in Rel. 11, virtual cell IDs are not defined for the SRS, and therefore virtual cell IDs for the SRS are defined newly when virtual cell IDs are employed.

In this case, the user terminals of each cell having received the interference report generates and transmits the SRS based on a virtual cell ID that is different from the connecting cell's cell ID (S204). Also, the SRS parameters (the amount of cyclic shift, comb, transmission bandwidth, and so on) can be made common between user terminals in each cell. For example, each user terminal calculates the amount of cyclic shift from the connecting cell's cell ID (for example, [cell ID/2] %6), calculates the comb from the connecting cell's cell ID (for example, cell ID %2), and, using the entire band for the transmission bandwidth, makes part of all of the UEs the transmitting UEs. Note that the time to transmit the SRS from each cell may be designated by the interfered cell (radio base station #1), may be reported from each cell that transmits the SRS, or may be set to arbitrary times.

Radio base station #1, having sent the interference report, tries to demodulate the SRSs transmitted from other cells' user terminals based on the SRS transmission parameters that can be determined from the cell ID of the subject cell and the cell IDs of nearby cells, and estimates each cell's interference level (S205). In this case, the interfered cell (radio base station #1) can demodulate the SRSs by using part or all of the symbols among the last symbols.

In this way, by applying common SRS parameters between user terminals and estimating the level of interference based on the signal level of aperiodic SRSs reported from each cell at predetermined times, it is possible to specify the interference source cell (interfering cell). In this case, it is not necessary to exchange each cell's SRS transmission parameters between cells. Note that when the interfered cell (radio base station #1) sends an interference report to nearby cells, it is also possible to measure the level of interference in the nearby cells (radio base station #2 and/or radio base station #3) based on the aperiodic SRSs transmitted from other cells.

Note that, after the interference source cell (cell #2) has been specified, the interfered cell (radio base station #1) can send an interference specifying report to the interference source cell, and, furthermore, specify the interfering UE, as has been described above with reference to FIG. 5. For example, in the case illustrated in FIG. 8B, the interfered cell (radio base station #1) sends an interference specifying report to cell #2 of the interference source (S206). Radio base station #2, having received the interference specifying report, specifies the user terminal that is causing significant interference against the interfered cell among the serving user terminals (S207). Furthermore, radio base station #2 can lower the transmission power of the specified interfering UE to a predetermined value (S208).

Also, referring to the step of specifying the interfering UE (S207), if interference resource block information and time information are not included in the interference specifying report, radio base station #2 can control specific user terminals to transmit the aperiodic SRS, selectively. By this means, it is possible to specify user terminals that cause interference by measuring the level of interference in the interfered cell. Note that, the specific method of operation in S205 to S208 in FIG. 8B may be carried out in the same way as in S105 to S108 of above FIG. 5B.

<SRS Sequence Extension>

Also, it is also possible to extend the SRS sequences beyond the existing sequence and establish orthogonality between cells (semi-orthogonalization). For example, sequences that are longer than the sequences (CAZAC sequences) provided for user terminals of Rel. 11 and earlier versions may be applied to user terminals of Rel. 12 and later versions.

Up to Rel. 11, among the CAZAC sequences, only maximum 60 are used. However, in actuality, it is possible to generate (N−1) sequences of the maximum prime number N smaller than the number of RBs×12. Consequently, when carrying out transmission in a wideband, there must be sequences that are not used.

So, to user terminals of Rel. 12 and later versions, the SRS sequences are extended and applied. By this means, even when virtual cell IDs are used, it is still possible to prevent interference of the SRS transmitted from each user terminal. Note that existing sequences may be applied to user terminals of Rel. 11 and earlier versions.

Also, as noted above, when the SRS sequences are extended, compared to existing sequences, it is possible to use a large number of sequences, so that it is also possible to establish the orthogonality of user terminals between cells as well. Consequently, by using orthogonal SRSs of extended sequences in all nearby cells, it becomes possible to detect the signal level of all user terminals.

(Structure of Radio Communication System)

Now, a radio communication system according to the present embodiment will be described below in detail. In this radio communication system, the above interference source (interfering cell) specifying methods according to the first and second examples are employed.

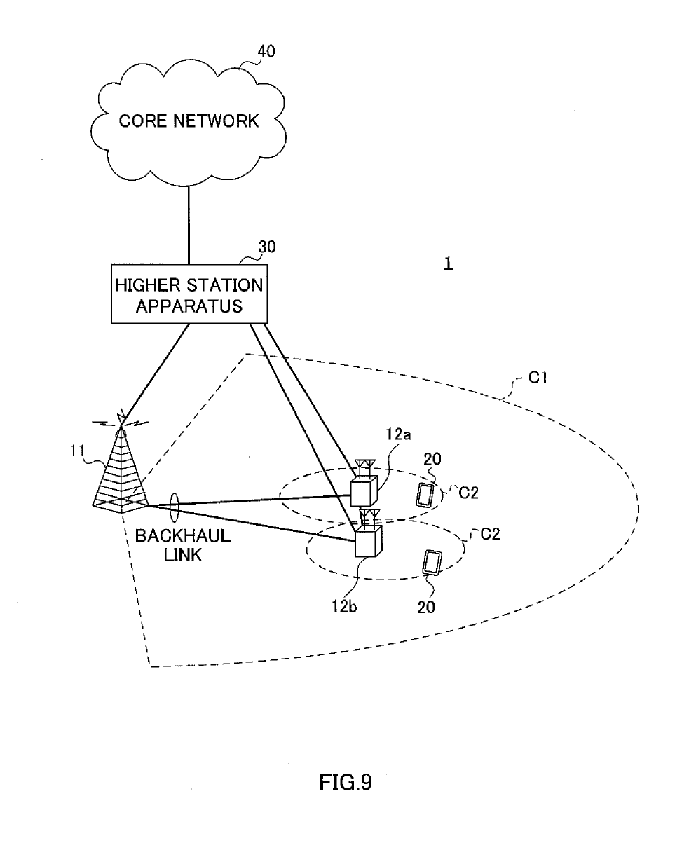

FIG. 9 is a schematic configuration diagram of a radio communication system according to the present embodiment. Note that the radio communication system illustrated in FIG. 9 is a system to accommodate, for example, the LTE system or SUPER 3G. This radio communication system can adopt carrier aggregation (CA) to group a plurality of fundamental frequency blocks (component carriers) into one, where the system bandwidth of the LTE system constitutes one unit. Also, this radio communication system may be referred to as “IMT-advanced,” or may be referred to as “4G” or “FRA (Future Radio Access).”

The radio communication system 1 illustrated in FIG. 9 includes a radio base station 11 that forms a macro cell C1, and radio base stations 12a and 12b that form small cells C2, which are placed in the macro cell C1, and which are narrower than the macro cell C1. Also, in the macro cell C1 and in each small cell C2, user terminals 20 are placed. The user terminals 20 can connect with both the radio base station 11 and the radio base stations 12 (dual connectivity). In this case, the user terminals 20 becomes capable of using the macro cell C1 and the small cells C2, which use separate frequencies, at the same time, by way of CA (carrier aggregation).

Between the user terminals 20 and the radio base station 11, communication is carried out using a carrier of a relatively low frequency band (for example, 2 GHz) and a narrow bandwidth (referred to as “existing carrier,” “legacy carrier” and so on). Meanwhile, between the user terminals 20 and the radio base stations 12, a carrier of a relatively high frequency band (for example, 3.5 GHz, etc.) and a wide bandwidth may be used, or the same carrier as that used in the radio base station 11 may be used. For the carrier type between the user terminals 20 and the radio base stations 12, a new carrier type (NCT) may be used. The connection between the radio base station 11 and the radio base stations 12 (or between the radio base stations 12) is implemented by wire connection (optical fiber, the X2 interface and so on) or by radio connection.

The radio base station 11 and the radio base stations 12 are each connected with a higher station apparatus 30, and connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus via the radio base station 11.

Note that the radio base station 11 is a radio base station having a relatively wide coverage, and may be referred to as an “eNodeB,” a “macro base station,” a “transmitting/receiving point” and so on. Also, the radio base stations 12 are radio base stations having local coverages, and may be referred to as “small base stations,” “pico base stations,” “femto base stations,” “Home eNodeBs,” “RRHs (Remote Radio Heads),” “micro base stations,” “transmitting/receiving points” and so on. Also, when no distinction is made between the radio base stations 11 and 12, these will be collectively referred to as the “radio base station 10.” The user terminals 20 are terminals to support various communication schemes such as LTE, LTE-A and so on, and may include both mobile communication terminals and fixed communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier transmission scheme to perform communication by dividing a frequency band into a plurality of narrow frequency bands (subcarriers) and mapping data to each subcarrier. SC-FDMA is a single-carrier transmission scheme to reduce interference between terminals by dividing the system band into bands formed with one or continuous resource blocks, per terminal, and allowing a plurality of terminals to use mutually different bands.

Now, communication channels to be used in the radio communication system illustrated in FIG. 9 will be described. Downlink communication channels include a PDSCH (Physical Downlink Shared CHannel), which is used by each user terminal 20 on a shared basis, and downlink L1/L2 control channels (a PDCCH, a PCFICH, a PHICH and an enhanced PDCCH). User data and higher control information are transmitted by the PDSCH. Scheduling information for the PDSCH and the PUSCH and so on are transmitted by the PDCCH (Physical Downlink Control CHannel). The number of OFDM symbols to use for the PDCCH is transmitted by the PCFICH (Physical Control Format Indicator CHannel). HARQ ACKs and NACKs in response to the PUSCH are transmitted by the PHICH (Physical Hybrid-ARQ Indicator CHannel). Also, the scheduling information for the PDSCH and the PUSCH and so on may be transmitted by the enhanced PDCCH (EPDCCH) as well. This EPDCCH is frequency-division-multiplexed with the PDSCH (downlink shared data channel).

Uplink communication channels include the PUSCH (Physical Uplink Shared CHannel), which is used by each user terminal 20 on a shared basis as an uplink data channel, and a PUCCH (Physical Uplink Control CHannel), which is an uplink control channel. User data and higher control information are transmitted by this PUSCH. Also, downlink radio quality information (CQI: Channel Quality Indicator), ACKs/NACKs and so on are transmitted by the PUCCH.

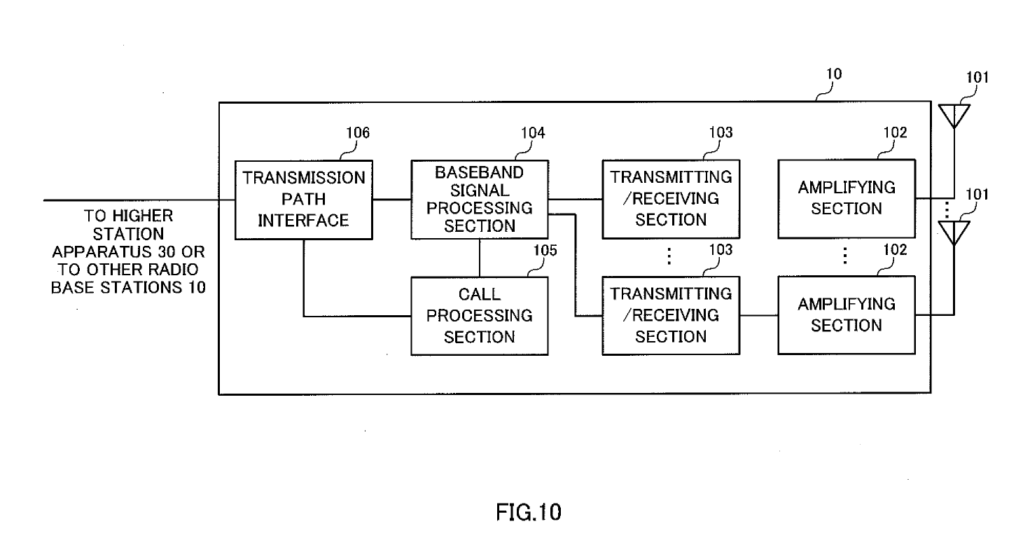

FIG. 10 is a diagram to illustrate an overall structure of a radio base station 10 (which covers the radio base stations 11 and 12) according to the present embodiment. The radio base station 10 has a plurality of transmitting/receiving antennas 101 for MIMO transmission, amplifying sections 102, transmitting/receiving sections 103, a baseband signal processing section 104, a call processing section 105 and a transmission path interface 106.

User data to be transmitted from the radio base station 10 to a user terminal 20 on the downlink is input from the higher station apparatus 30, into the baseband signal processing section 104, via the transmission path interface 106.

In the baseband signal processing section 104, a PDCP layer process, division and coupling of the user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a pre-coding process are performed, and the result is transferred to each transmitting/receiving section 103. Furthermore, downlink control channel signals are also subjected to transmission processes such as channel coding and an inverse fast Fourier transform, and are transferred to each transmitting/receiving section 103.

Also, the baseband signal processing section 104 reports, to the user terminal 20, control information for allowing communication in the cell, through a broadcast channel. The information for allowing communication in the cell includes, for example, the uplink or downlink system bandwidth and so on. Each transmitting/receiving section 103 converts the baseband signals, which are pre-coded and output from the baseband signal processing section 104 on a per antenna basis, into a radio frequency band. The amplifying sections 102 amplify the radio frequency signals having been subjected to frequency conversion, and transmit the results through the transmitting/receiving antennas 101.

On the other hand, as for data that is transmitted from the user terminal 20 to the radio base station 10 on the uplink, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, the user data that is included in the input baseband signals is subjected to an FFT process, an IDFT process, error correction decoding, a MAC retransmission control receiving process and RLC layer and PDCP layer receiving processes, and the result is transferred to the higher station apparatus 30 via the transmission path interface 106. The call processing section 105 performs call processing such as setting up and releasing communication channels, manages the state of the radio base station 10 and manages the radio resources.

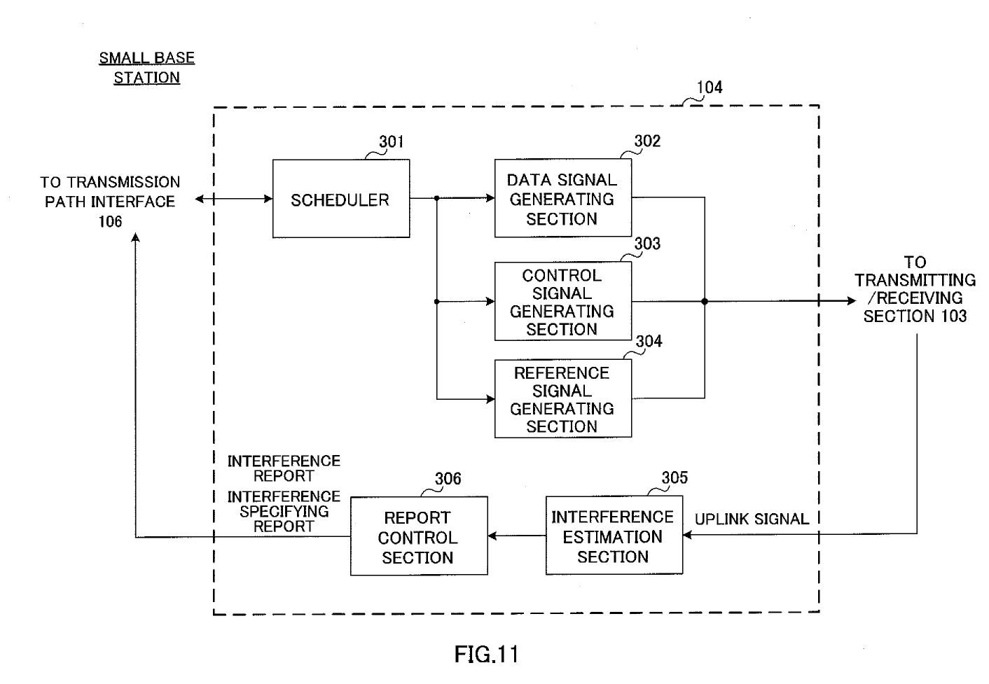

FIG. 11 is a principle functional configuration diagram of a baseband signal processing section 104 provided in a small base station (radio base station 12) according to the present embodiment. As illustrated in FIG. 11, baseband signal processing section 104 provided in the radio base station 12 is formed by including a scheduler 301, a data signal generating section 302, a control signal generating section 303, a reference signal generating section 304, an interference estimation section 305 and a report control section 306.

The scheduler 301 controls the scheduling of the downlink user data to be transmitted in the PDSCH, the downlink control information to be transmitted in the PDCCH and/or the enhanced PDCCH (EPDCCH), and the downlink reference signals. Also, the scheduler 301 schedules the uplink user data to be transmitted in the PUSCH, the uplink control information that is transmitted in the PUCCH, and the uplink reference signals (allocation control) as well. Information about the allocation control for the uplink signals is reported to the user terminals by using a downlink control signal (DCI).

To be more specific, the scheduler 301 allocates radio resources for the downlink signals and the uplink signals based on command information from the higher station apparatus 30, feedback information (for example, CSI including CQIs, RIs and so on) from each user terminal 20, and so on. Note that, when radio resources are allocated based on commands from the macro base station (radio base station 11), a configuration may be employed in which no scheduler 301 is provided.

When the above first example is employed, based on interference reports from other cells (interfered cells) and so on, the scheduler 301 executes control so that predetermined resource positions in the uplink signals transmitted from the serving user terminals assume the blank state. When the above second example is employed, based on interference reports from other cells (interfered cells) and so on, the scheduler 301 executes control so that the serving user terminals transmit aperiodic SRSs.

Note that the information determined in the scheduler 301 may be included in downlink control signals generated in the control signal generating section 303, or may be included in downlink data signals generated in data signal generating section 302 as higher layer signaling. For example, aperiodic SRS trigger information can be included and reported in downlink control information (DCI). Also, when a user terminal that is interfering with an interfered cell is specified, the scheduler 301 can control the transmission power of the user terminal to lower.

The data signal generating section 302 generates data signals (PDSCH signals), the allocation of which to resources is determined in the scheduler 301. The data signals that are generated in the data signal generating section 302 are subjected to a coding process and a modulation process, based on coding rates and modulation schemes that are determined based on CSI from each user terminal 20 and so on.

The control signal generating section 303 generates control signals (PDCCH signals and/or EPDCCH signals) for the user terminals 20, the allocation of which to each subframe is determined in the scheduler 301. To be more specific, based on commands from the scheduler 301, the control signal generating section 303 generates downlink control information so that the serving user terminals transmit interference measurement SRSs for measuring interference from other cells.

The reference signal generating section 304 generates various reference signals to transmit on the downlink. For example, the reference signal generating section 304 generates cell-specific reference signals (CRSs), channel state measurement signals (CSI-RSs), user-specific reference signals for the PDSCH (DM-RSs), demodulation reference signals for the EPDCCH (DM-RSs), position-adjustment reference signals (PRSs), and so on.

The interference estimation section 305 estimates the level of interference received from other cells, based on uplink signals transmitted from other cells' user terminals, and specify the cell being the source of interference. When the above first example is employed, the interference estimation section 305 estimates the level of interference, per cell, based on the uplink signal (the PUSCH signal and/or the DM-RS), in which resource positions that vary between the cells assume the blank state. In this case, the interference estimation section 305 measures the power of each blanking pattern, in each cell, and estimates the level of interference on a per cell basis. For example, the level of interference (1k) from a given cell k can be calculated by using above equation 1 or equation 2.

When the above second example is employed, the interference estimation section 305 demodulates the SRSs transmitted from other cells (user terminals connected to the small base stations of other cells) and estimates each cell's interference level from the signal levels of the SRSs. Then, based on each cell's interference level, the interference estimation section 305 estimates the cell (interfered cell) that causes strong interference.

Also, the interference estimation section 305 can determine whether or not interference is received from nearby cells. In this case, without specifying the interference source cell (interfering cell), the interference estimation section 305 can estimate the level of interference by using existing DM-RSs and so on.

When the interference estimation section 305 determines that the level of interference being received from the radio base stations of nearby cells is equal to or higher than a predetermined value, the report control section 306 controls the interference report (OI) to nearby cells to the effect that interference is being received. Alternatively, when the interference estimation section 305 specifies the interference source cell (interfering cell) that is causing strong interference against the subject cell, the report control section 306 controls the interference specifying report to the interference source cell.

The report control section 306 can send an interference report and an interference specifying report by using, for example, a backhaul (for example, the X2 interface) and so on. Furthermore, the report control section 306 may add, to the interference specifying report, information about the time strong interference is observed, in addition to interference resource block (RB) information. By this means, the scheduler 301 of the interfering cell can specify the serving user terminal that is causing interference, based on the history of scheduling information in the subject cell. In this case, the scheduler 301 functions as a specifying section that specifies the interfering UE.

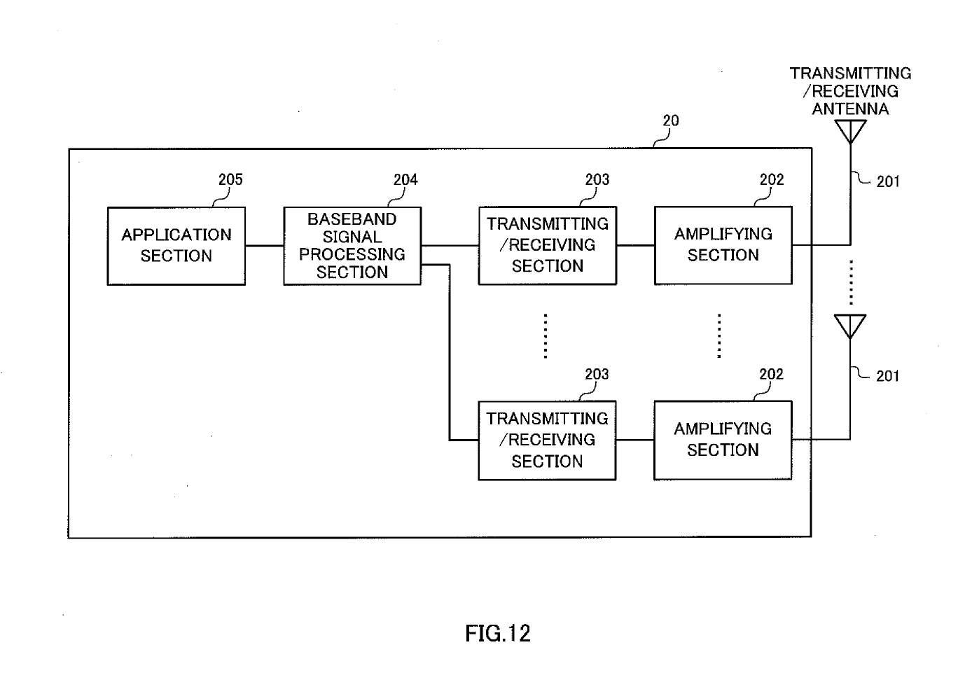

FIG. 12 is a diagram to illustrate an overall structure of a user terminal 20 according to the present embodiment. The user terminal 20 has a plurality of transmitting/receiving antennas 201 for MIMO transmission, amplifying sections 202, transmitting/receiving sections (receiving sections) 203, a baseband signal processing section 204, and an application section 205.

As for downlink data, radio frequency signals that are received in a plurality of transmitting/receiving antennas 201 are each amplified in the amplifying sections 202, and subjected to frequency conversion and converted into baseband signals in the transmitting/receiving sections 203. These baseband signals are subjected to an FFT process, error correction decoding, a retransmission control receiving process and so on, in the baseband signal processing section 204. In this downlink data, downlink user data is transferred to the application section 205. The application section 205 performs processes related to higher layers above the physical layer and the MAC layer, and so on. Also, in the downlink data, broadcast information is also transferred to the application section 205.

Meanwhile, uplink user data is input from the application section 205 into the baseband signal processing section 204. The baseband signal processing section 204 performs a retransmission control (HARQ (Hybrid ARQ)) transmission process, channel coding, pre-coding, a DFT process, an IFFT process and so on, and transfers the result to each transmitting/receiving section 203. The baseband signals that are output from the baseband signal processing section 204 are converted into a radio frequency band in the transmitting/receiving sections 203. After that, the amplifying sections 202 amplify the radio frequency signals having been subjected to frequency conversion, and transmit the results from the transmitting/receiving antennas 201.

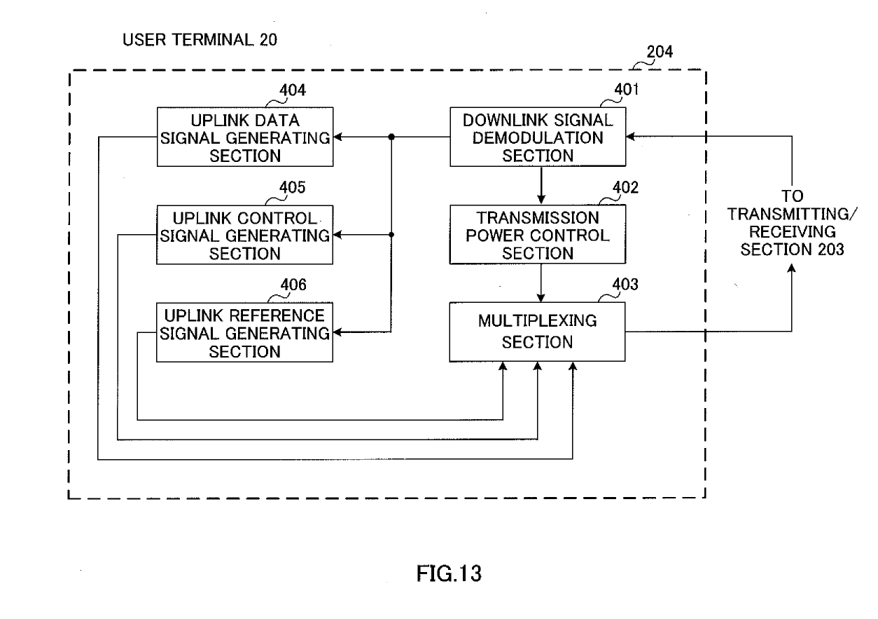

FIG. 13 is a principle functional configuration diagram of the baseband signal processing section 204 provided in a user terminal 20. As illustrated in FIG. 13, the baseband signal processing section 204 provided in the user terminal 20 at least has a downlink signal demodulation section 401, a transmission power control section 402, a multiplexing section 403, an uplink data signal generating section 404, an uplink control signal generating section 405 and an uplink reference signal generating section 406.

The downlink signal demodulation section 401 demodulates the downlink signals transmitted from the connecting radio base station (for example, a radio base station 12). To be more specific, the downlink signal demodulation section 401 demodulates the downlink data signal and the downlink control signal. The downlink control signal includes scheduling information for uplink transmission (uplink signal resource allocation information, aperiodic SRS trigger information, transmission power information and so on). Also, the downlink data signal includes information that is reported through higher layer signaling.

The transmission power control section 402 controls the transmission power of the uplink signals (the PUSCH signal, the PUCCH signal and the uplink reference signal). For example, based on power control commands (TPC) reported from the radio base station, the transmission power control section 402 controls the transmission power of each uplink signal. In the radio base station 12, when the user terminal is specified as a user terminal to cause strong interference against an interfered cell, report to the effect that the transmission power should be lowered is sent from the radio base station 12. Also, when making part of the resources of the uplink signals (the PUSCH and/or the DM-RS) zero power, this can be controlled in the transmission power control section 402.

The uplink data signal generating section 404 generates the uplink data signal (PUSCH signal) based on uplink scheduling information that is included in the downlink control information. Also, when making part of the resources of the PUSCH blank, the uplink data signal generating section 404 can generate the uplink data signal based on the blanking RE pattern that is associated with the cell ID. Information about the blanking pattern (the time to carry out blanking and so on) is reported through higher layer signaling, downlink control information and so on.

The uplink reference signal generating section 406 generates the DM-RS and the SRS, which are uplink reference signals. When the above first example is employed, the uplink reference signal generating section 406 generates the reference signals so that predetermined resource positions in the DM-RS assume the blank state. Also, when the above second example is employed, the uplink reference signal generating section 406 generates the aperiodic SRS. Note that the uplink reference signal generating section n 406 can generate the aperiodic SRS by using the sequence of the virtual cell ID that is associated with the cell ID of the interfered cell of the source of the report.

The uplink control signal generating section 405 generates uplink control signals (PUCCH signal) such as delivery acknowledgment signals (ACKs/NACKs) in response to the PDSCH, channel state information (CSI) and so on. Also, the multiplexing section 403 multiplexes the uplink data signal generated in the uplink data signal generating section 404, the uplink control signal generated in the uplink control signal generating section 405 and the uplink reference signal generated in the uplink reference signal generating section 406, and outputs the result to the transmitting/receiving section 203.

Now, although the present invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of the claims. For example, a plurality of examples described above may be combined and implemented as appropriate. Consequently, the descriptions herein are provided only for the purpose of explaining examples, and should by no means be construed to limit the present invention in any way.

The disclosure of Japanese Patent Application No. 2013-077104, filed on Apr. 2, 2013, including the specification, drawings and abstract, is incorporated herein by reference in its entirety.

1. A radio base station comprising:
a receiving section that receives an uplink signal transmitted from a user terminal; and
an interference estimation section that estimates a level of interference received from an other cell based on an uplink signal transmitted from a user terminals of the other cell,
wherein the interference estimation section estimates the level of interference of each cell based on the uplink signal, and a blank state is assumed in the uplink signal at a resource position that varies on a per cell basis.

2. The radio base station according to claim 1, further comprising a control section that controls a predetermined resource position in an uplink signal to be transmitted from a serving user terminal to assume the blank state.

3. The radio base station according to claim 2, wherein, when an interference report is received from another cell, the control section controls the predetermined resource position in the uplink signal to be transmitted from the serving user terminal to assume the blank state.

4. The radio base station according to claim 2, wherein the control section controls part of resources of an uplink shared channel signal and/or a demodulation reference signal to assume the blank state.

5. The radio base station according to claim 1, wherein the interference estimation section determines the level of interference from the other cell based on transmission power of resources assuming the blank state in the uplink signal.

6. The radio base station according to claim 1, further comprising a reporting section that, when the level of interference received from a nearby cell is equal to or greater than a predetermined value, sends an interference report to the nearby cell.

7. The radio base station according to claim 6, wherein the reporting section sends an interference specifying report which includes information relating to an interference resource block and/or an interference time, to a specific cell whose level of interference is determined to be equal to or higher than the predetermined value in the interference estimation section.

8. The radio base station according to claim 7, further comprising a specifying section that, when an interference specifying report is received from the other cell, specifies a user terminal that interferes with the other cell among serving user terminals.

9. A user terminal comprising:
a receiving section that receives a downlink signal from a radio base station; and
a generating section that generates an uplink signal based on information included in the downlink signal,
wherein the generating section generates the uplink signal such that a resource position that is common between user terminals connected to the radio base station assumes a blank state.

10. A radio communication method for a radio base station and a user terminal, comprising:
in the radio base station, receiving an uplink signal transmitted from the user terminal; and
in the radio base station, estimating a level of interference received from an other cell, based on an uplink signal transmitted from a user terminal of the other cell,
wherein upon the estimation of the level of interference, the level of interference of each cell is estimated based on the uplink signal, and a blank state is assumed in the uplink signal at a resource position that varies on a per cell basis.

11. The radio base station according to claim 3, wherein the control section controls part of resources of an uplink shared channel signal and/or a demodulation reference signal to assume the blank state.
